(19) United States
(12) Patent Application Publication
(10) Pub. No.: US 2011/0214099 A1
(43) Pub. Date: Sep. 1, 2011

(54) CIRCUIT DIAGRAM GENERATION SYSTEM AND METHOD

(75) Inventors: YUNG-CHIEH CHEN, Tu-Cheng,Taipei Hsien (TW); SHOU-KUO HSU, Tu-Cheng,Taipei Hsien (TW)

(73) Assignee: HON HAI PRECISION INDUSTRY CO., LTD., Tu-Cheng (TW)

(21) Appl. No.: 12/884,204

(22) Filed: Sep. 17, 2010

(30) Foreign Application Priority Data
Feb. 26, 2010 (CN) 201010114886.4

(51) Int. Cl. G06F 17/50

(52) U.S. Cl. 716/112

(57) ABSTRACT

In a method and system for automatically generating a circuit diagram for a wiring design of a circuit board, a preset output format of wiring attributes of the wiring design for the circuit board is received. A board file is created. Initial parameters of the wiring design for the circuit board are preset. The wiring attributes of the wiring design are determined by simulating and analyzing the wiring design, and be backed up into a document. The wiring attributes are imported into the board file according to the preset output format. A circuit diagram is generated according to the wiring design and the initial parameters, and is adjusted using the wiring attributes in the board file.

### BACKGROUND

1. Technical Field

Embodiments of the present disclosure generally relate to systems and methods for circuit board design, and more particularly to a system and a method for automatically generating a circuit diagram according to a wiring design of a circuit board.

2. Description of Related Art

Designs of an electronic device (e.g., a computer, or a mobile phone) usually include a wiring design for a circuit board of the electronic device, and simulating and analyzing the wiring design, to determine wiring attributes of the wiring design. The wiring attributes of the wiring design include electronic rules (e.g., a max via count on the circuit board) and physical rules (e.g., a net physical type, and a net spacing type). A circuit diagram of the circuit board is designed according to the wiring design.

Design Entry HDL is a software platform for design of circuit boards of electronic devices provided by CADENCE. However, using the Design Entry HDL, the circuit diagram cannot be automatically adjusted according to the wiring attributes, but needs to be manually adjusted by layout engineers.

### BRIEF DESCRIPTION OF THE DRAWINGS

FIG. 1 is a block diagram illustrating one embodiment of a system for automatically generating a circuit diagram according to a wiring design for a circuit board.

FIG. 2 is a block diagram illustrating one embodiment of function modules of a circuit diagram generation unit in FIG. 1.

FIG. 3 is an example of an output format of wiring attributes of a wiring design.

FIG. 4 is a flowchart illustrating one embodiment of a method for automatically generating a circuit diagram according to a wiring design for a circuit board.

### DETAILED DESCRIPTION

The application is illustrated by way of examples and not by way of limitation in the figures of the accompanying drawings in which like references indicate similar elements. It should be noted that references to “an” or “one” embodiment in this disclosure are not necessarily to the same embodiment, and such references mean at least one.

In general, the word “module” as used hereinafter, refers to logic embodied in hardware or firmware, or to a collection of software instructions, written in a programming language, for example, Java, C, or assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

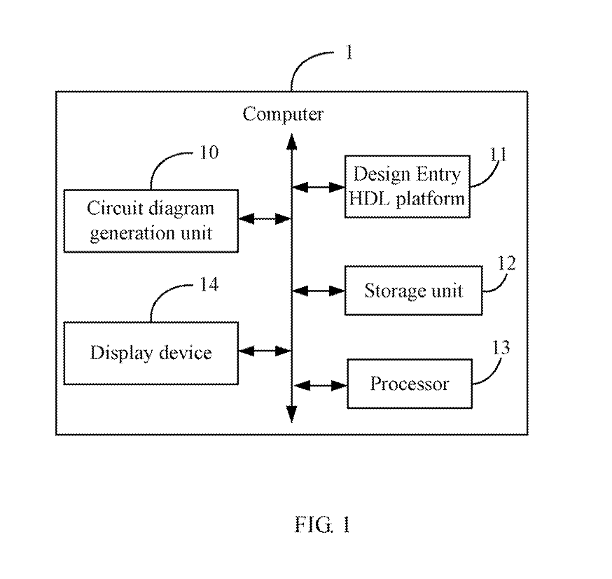

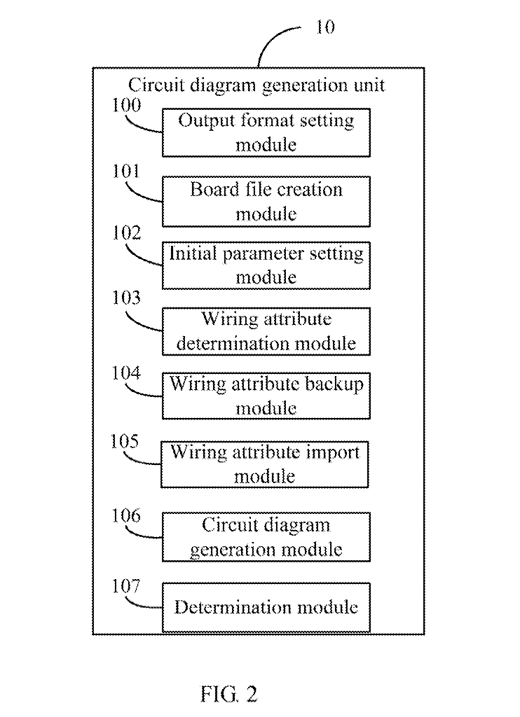

FIG. 1 is a block diagram illustrating one embodiment of a system for automatically generating a circuit diagram according to a wiring design for a circuit board. In some embodiments, the system is a computer 1 that includes a circuit diagram generation unit 10, a Design entry HDL platform 11, a storage unit 12, a processor 13, and a display device 14. The circuit diagram generation unit 10 includes a plurality of function modules (see below descriptions referring to FIG. 2), to automatically generate and adjust a circuit diagram according to a wiring design and wiring attributes of the wiring design on the Design entry HDL platform 2. The function modules of the circuit diagram generation unit 10 may include one or more computerized codes in the form of one or more programs that are stored in the storage unit 12. The one or more computerized codes include instructions that are executed by the processor 13, to provide functions for the function modules of the circuit diagram generation unit 10.

FIG. 2 is a block diagram illustrating the function modules of the circuit diagram generation unit 10. In some embodiments, the function modules of the circuit diagram generation unit 10 may include an output format setting module 100, a board file creation module 101, an initial parameter setting module 102, a wiring attribute determination module 103, a wiring attribute backup module 104, a wiring attribute import module 105, a circuit diagram generation module 106, and a determination module 107.

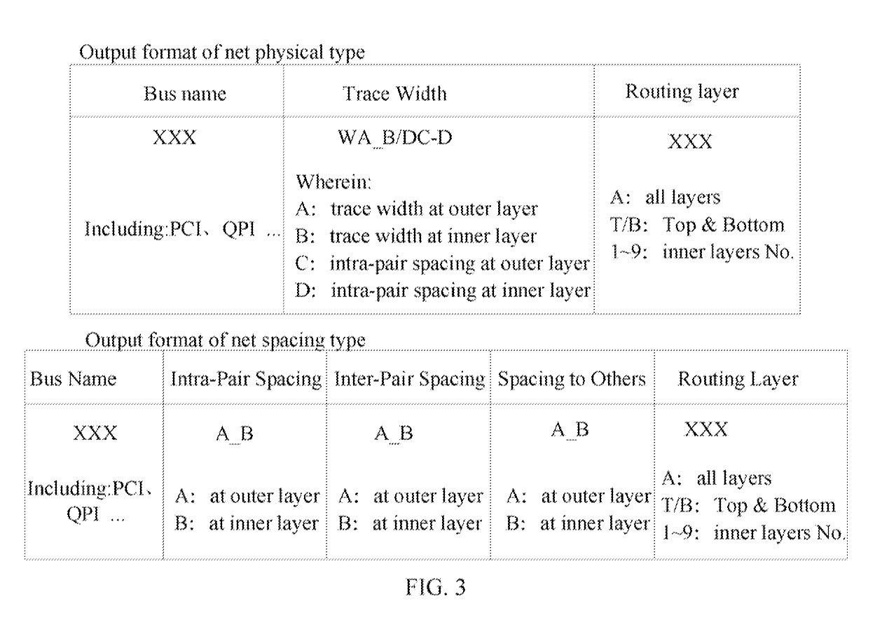

The output format setting module 100 receives a preset output format of wiring attributes of the wiring design for the circuit board. The wiring attributes include electronic rules (e.g., a max via count on the circuit board) and physical rules (e.g., a net physical type, and a net spacing type). In the present embodiment, the preset output format is for the physical rules. One example of the preset output format of the physical rules is shown in FIG. 3.

The board file creation module 101 creates a board file by designating a file name (e.g., “123.brd”).

The initial parameter setting module 102 sets initial parameters of the wiring design for the circuit board. In some embodiments, the initial parameters may include stepped construction of the circuit board and a number of power supplies on the circuit board, for example.

The wiring attribute determination module 103 determines the wiring attributes of the wiring design by simulating and analyzing the wiring design on the Design entry HDL platform 2. The wiring attributes may include max via count, stub length, a max/min/relative trace length, a phase tolerance, a net physical type, and/or a net spacing type, for example. The net physical type may include a trace width and a routing layer, for example. The net spacing type may include intra-pair spacing, inter-pair spacing, spacing to others, and router layer, for example.

The wiring attribute backup module 104 backs up the wiring attributes into a document. In some embodiments, the document is a dcf document. It may be appreciated that, the dcf document is a document having a dcf format.

The wiring attribute import module 105 imports the wiring attributes into the board file according to the preset output format.

The circuit diagram generation module 106 generates a circuit diagram according to the wiring design and the initial parameters, applies the wiring attributes to the circuit diagram using the board file, and displays the circuit diagram on the display device 14 of the computer 1.

The determination module 107 determines if there are any mistakes of the wiring attributes applied to the circuit diagram, obtains the dcf document and fetches the wiring attributes from the dcf document if there are any mistakes of the wiring attributes applied to the circuit diagram, to import the new fetched wiring attributes into the board file and newly generate a circuit diagram.

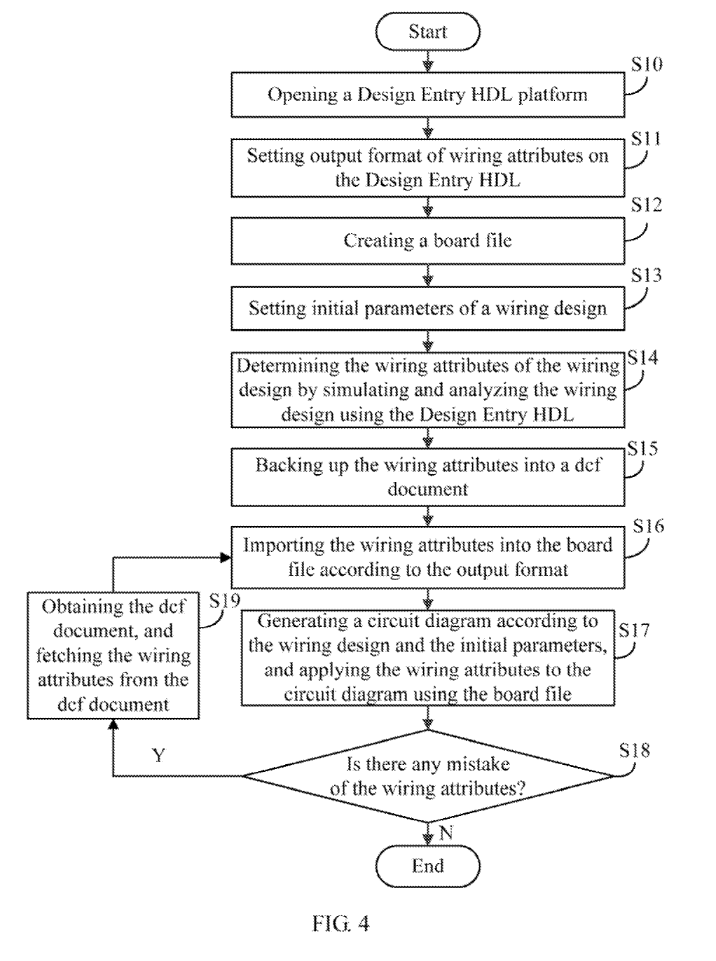

FIG. 4 is a flowchart illustrating one embodiment of a method for automatically generating a circuit diagram according to a wiring design for a circuit board. In one embodiment, the method runs on the Design entry HDL platform 2.

In block S10, the Design Entry HDL platform 2 is opened.

In block S11, the output format setting module 100 receives a preset output format of wiring attributes of the wiring design for the circuit board. The wiring attributes includes electronic rules (e.g., a max via count on the circuit board) and physical rules (e.g., a net physical type, and a net spacing type). In the present embodiment, the preset output format is for the physical rules. One example of the preset output format of the physical rules is shown in FIG. 3.

In block S12, the board file creation module 101 creates a board file by designating a file name (e.g., “123.brd”).

In block S13, the initial parameter setting module 102 sets initial parameters of the wiring design for the circuit board. In some embodiments, the initial parameters may include stepped construction of the circuit board and a number of power supplies on the circuit board, for example.

In block S14, the wiring attribute determination module 103 determine the wiring attributes of the wiring design by simulating and analyzing the wiring design on the Design entry HDL platform 2. The wiring attributes may include max via count, stub length, max/min/relative trace length, phase tolerance, a net physical type, and/or a net spacing type, for example. The net physical type may include trace width and routing layer, for example. The net spacing type may include intra-pair spacing, inter-pair spacing, spacing to others, and router layer, for example.

In block S15, the wiring attribute backup module 104 backs up the wiring attributes into a document. In some embodiments, the document is a dcf document. It may be appreciated that, the dcf document is a document having a dcf format.

In block S16, the wiring attribute import module 105 imports the wiring attributes into the board file according to the preset output format.

In block S17, the circuit diagram generation module 106 generates a circuit diagram according to the wiring design and the initial parameters, applies the wiring attributes to the circuit diagram using the board file, and displays the circuit diagram on the display device 14 of the computer 1.

In block S18, the determination module 107 determines if there are any mistakes of the wiring attributes applied to the circuit diagram. Block S19 is implemented if there are any mistakes of the wiring attributes applied to the circuit diagram. Otherwise, the flow ends.

In block S19, the determination module 107 obtains the dcf document, and obtains the wiring attributes from the dcf document. After block S19, blocks S16 to S18 are repeated.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method for automatically generating a circuit diagram for a wiring design of a circuit board, the method being performed by execution of computer readable program code by at least one processor of at least one computer system, the method comprising:
(a) receiving a preset output format of wiring attributes of the wiring design for the circuit board;
(b) creating a board file;
(c) setting initial parameters of the wiring design for the circuit board;
(d) determine the wiring attributes of the wiring design by simulating and analyzing the wiring design;
(e) backing up the wiring attributes into a document;
(f) importing the wiring attributes into the board file according to the preset output format; and
(g) generating a circuit diagram according to the wiring design and the initial parameters, applying the wiring attributes to the circuit diagram using the board file, and displaying the circuit diagram on a display device.

2. The method as described in claim 1, further comprising:
(h) fetching the wiring attributes from the document if there are any mistakes of the wiring attributes applied to the circuit diagram, and repeating from (f) to (g).

3. The method as described in claim 1, wherein the document is a dcf format document.

4. The method as described in claim 1, wherein the method is performed on a Design entry HDL platform.

5. The method as described in claim 1, wherein the wiring attributes of the wiring design comprise electronic rules and physical rules.

6. The method as described in claim 1, wherein the initial parameters comprise stepped construction of the circuit board, and a number of power supplies on the circuit board.

7. A non-transitory storage medium having stored thereon instructions that, when executed by a processor, cause the processor to perform a method for automatically generating a circuit diagram for a wiring design of a circuit board, wherein the method comprises:
(a) receiving a preset output format of wiring attributes of the wiring design for the circuit board;
(b) creating a board file;
(c) setting initial parameters of the wiring design for the circuit board;
(d) determine the wiring attributes of the wiring design by simulating and analyzing the wiring design;
(e) backing up the wiring attributes into a document;
(f) importing the wiring attributes into the board file according to the preset output format; and
(g) generating a circuit diagram according to the wiring design and the initial parameters, applying the wiring attributes to the circuit diagram using the board file, and displaying the circuit diagram on a display device.

8. The non-transitory storage medium as described in claim 7, wherein the method further comprises:
(h) fetching the wiring attributes from the document if there are any mistakes of the wiring attributes applied to the circuit diagram, and repeating from (f) to (g).

9. The non-transitory storage medium as described in claim 7, wherein the document is a dcf format document.

10. The non-transitory storage medium as described in claim 7, wherein the method is performed on a Design entry HDL platform.

11. The non-transitory storage medium as described in claim 7, wherein the wiring attributes of a wiring design comprise electronic rules and physical rules.

12. The non-transitory storage medium as described in claim 7, wherein the initial parameters comprise stepped construction of the circuit board, and a number of power supplies on the circuit board.

13. A system for automatically generating a circuit diagram for a wiring design of a circuit board in an electronic device, the system comprising:
at least one processor;
storage unit;
one or more programs that are stored in the storage unit and are executed by the at least one processor, the one or more programs comprising:
an output format setting module to receive a preset output format of wiring attributes of the wiring design for the circuit board;
a board file creation module to create a board file;
an initial parameter setting module to set initial parameters of the wiring design for the circuit board;
a wiring attribute determination module to determine the wiring attributes of the wiring design by simulating and analyzing the wiring design;
a wiring attribute backup module to back up the wiring attributes into a document; and
a wiring attribute import module to import the wiring attributes into the board file according to the preset output format; and
a circuit diagram generation module to generate a circuit diagram according to the wiring design and the initial parameters, apply the wiring attributes to the circuit diagram using the board file, and display the circuit diagram on a display device.

14. The system as described in claim 13, further comprising:
a determination module to determine if there are any mistakes of the wiring attributes applied to the circuit diagram, obtains the document and fetch the wiring attributes from the document if there are any mistakes applied to the circuit diagram, to import the fetched wiring attributes into the board file.

15. The system as described in claim 13, wherein the document is a dcf format document.

16. The system as described in claim 13, wherein the system is executed on a Design entry HDL platform.

17. The system as described in claim 13, wherein the wiring attributes of a wiring design comprise electronic rules and physical rules.

18. The system as described in claim 13, wherein the initial parameters comprise stepped construction of the circuit board, and a number of power supplies on the circuit board.
